(19) United States
(12) Patent Application Publication
(10) Pub. No.: US 2021/0261872 A1
(43) Pub. Date: Aug. 26, 2021

(54) TWO-STEP HYDROCRACKING METHOD USING A PARTITIONED DISTILLATION COLUMN

(71) Applicant: IFP Energies nouvelles, Rueil-Malmaison Cedex (FR)

(72) Inventors: Thomas PLENNEVAUX, Rueil-Malmaison Cedex (FR); Emmanuelle GUILLON, Rueil-Malmaison Cedex (FR); Sophie COUDERC, Rueil-Malmaison Cedex (FR); Audrey BONDUELLE-SKRZYPCZAK, Rueil-Malmaison Cedex (FR)

(73) Assignee: IFP Energies nouvelles, Rueil-Malmaison Cedex (FR)

(21) Appl. No.: 17/260,853

(22) PCT Filed: Jul. 4, 2019
(86) PCT No.: PCT/EP2019/068035

§ 371 Date: Jan. 15, 2021

(30) Foreign Application Priority Data
Jul. 16, 2018 (FR) 1856538

(51) Int. Cl. C10G 65/12; B01D 3/14

(52) U.S. Cl. CPC C10G 65/12; B01D 3/141; C10G 2300/1074; C10G 2300/4006; C10G 2400/08; C10G 2400/02; C10G 2400/04; C10G 2400/06; C10G 2300/4012

(57) ABSTRACT

A two-step hydrocracking process with a distillation step wherein a dividing wall distillation column is used, the dividing wall dividing the lower part of the column into two compartments, located in the section of the column located under the supply of said column with the unconverted effluent resulting from the first hydrocracking step. The distillation column is fed on either side of the vertical dividing wall with the liquid hydrocarbon effluent from the first hydrocracking step and with the liquid hydrocarbon effluent from the second hydrocracking step, allowing the concentration of the HPNAs contained in the effluent from the second hydrocracking step in a specific compartment of the column delimited by the dividing wall and avoiding the dilution of said HPNAs by the unconverted effluent from the first hydrocracking step. The present invention allows purging of purer HPNAs.

### TECHNICAL FIELD OF THE INVENTION

The invention relates to a two-step hydrocracking process that makes it possible to eliminate the heavy polycyclic aromatic compounds (HPNAs) without reducing the yield of upgradable products.

Hydrocracking processes are commonly used in refinery for transforming hydrocarbon mixtures into readily upgradable products. These processes may be used to transform light cuts, for instance petroleums, into lighter cuts (LPG). However, they are customarily used more for converting heavier feedstocks (such as heavy synthetic or petroleum cuts, for example gas oils resulting from vacuum distillation or effluents from a Fischer-Tropsch unit) into petroleum or naphtha, kerosene, gas oil.

Certain hydrocracking processes make it possible to also obtain a highly purified residue that may constitute excellent bases for oils. One of the effluents that is particularly targeted by the hydrocracking process is middle distillate (fraction which contains the gas oil cut and the kerosene cut), i.e. cuts with an initial boiling point of at least 150° C. and with a final boiling point ranging up to just before the initial boiling point of the residue, for example below 340° C., or else below 370° C.

Hydrocracking is a process which draws its flexibility from three main elements which are: the operating conditions used, the types of catalysts employed and the fact that the hydrocracking of hydrocarbon feedstocks may be carried out in one step or in two steps.

In particular, the hydrocracking of vacuum distillates or VDs makes it possible to produce light cuts (gas oil, kerosene, naphthas, and the like) which are more upgradable than the VD itself. This catalytic process does not make it possible to completely convert the VD into light cuts. After fractionation, there thus remains a more or less significant proportion of unconverted VD fraction, referred to as UCO or UnConverted Oil. To increase the conversion, this unconverted fraction may be recycled to the inlet of the hydrotreating reactor or to the inlet of the hydrocracking reactor in the case of a one-step hydrocracking process or to the inlet of a second hydrocracking reactor treating the unconverted fraction at the end of the fractionating step, in the case of a two-step hydrocracking process.

It is known that the recycling of said unconverted fraction from the separating step to the second hydrocracking step of a two-step process results in the formation of heavy (polycyclic) aromatic compounds referred to as HPNAs during the cracking reactions and thus in the undesirable accumulation of said compounds in the recycle loop, resulting in the degradation of the performance of the catalyst of the second hydrocracking step and/or in the fouling thereof. A purge is generally installed in the recycling of said unconverted fraction, in general in the fractionation bottoms line, in order to reduce the concentration, in the recycle loop, of HPNA compounds, the purge flow rate being adjusted so as to balance the formation flow rate thereof. Specifically, the heavier the HPNAs, the greater their tendency to remain in this loop, to accumulate, and to grow heavier.

However, the conversion in a two-step hydrocracking process is directly linked to the amount of heavy products purged at the same time as the HPNAs.

Depending on the operating conditions of the process, said purge may be between 0 and 5% by weight of the heavy fraction relative to the incoming VD mother feedstock, and preferably between 0.5% and 3% by weight. The yield of upgradable products is therefore reduced accordingly, which constitutes a not inconsiderable economic loss for the refiner.

Throughout the remainder of the text, the HPNA compounds are defined as polycyclic or polynuclear aromatic compounds which therefore comprise several fused benzene nuclei or rings. They are usually referred to as HPAs, for Heavy Polynuclear Aromatics, PNAs or HPNAs. These compounds, formed during undesirable side reactions, are stable and virtually impossible to hydrocrack. Typically, “heavy” HPNAs are polycyclic aromatic hydrocarbon compounds consisting of several fused benzene rings such as, for example, coronene (compound with 24 carbons), dibenzo(e, ghi)perylene (26 carbons), naphtho[8,2,1-abc]coronene (30 carbons) and ovalene (32 carbons), which are the most easily identifiable and quantifiable compounds, for example by chromatography.

### PRIOR ART

Patent application WO 2016/102302 describes a process for concentrating HPNAs in the unconverted fraction or residue in order to eliminate them and to reduce the amount of residue purged so as to increase the conversion but also to improve the yield of upgradable products by drawing off a sidestream below the feed point of the fractionation column, the withdrawn stream having a low concentration of HPNAs and a high proportion of hydrocarbons that have not been converted in the upstream hydrocracking section. A stripping gas can also be injected into the lowest section of the fractionation column below the feed plate and above the residue discharge point in order to strip the distillation residue and thus concentrate the heaviest compounds in said residue before fully purging said residue. This makes it possible to limit the loss of yield associated with the dilution of the HPNAs in the purge.

A second drawing off of a side stream having a low concentration of HPNAs and a high proportion of unconverted hydrocarbons can advantageously be carried out between the feed plate and the plate for drawing off the heaviest distillate fraction. This second withdrawn stream can be stripped in an external stripping column, following which all or part of the separated gaseous effluent is recycled to the column and all or part of the liquid effluent is recycled to the hydrocracking step. In this process, no step of recycling the unconverted residue to the fractionation column is carried out. The unconverted residue is also not recycled to the hydrocracking step. It is entirely purged.

U.S. Pat. No. 8,852,404 describes a process for hydrocracking hydrocarbon feedstocks wherein a fractionation column comprising a vertical dividing wall in the lower section of said column, thus creating two compartments, allows the concentration of HPNAs in one of the compartments of said column, before elimination or purging thereof, using said compartment as a stripper. The objective of this implementation is to use the resulting vapor from the HPNA stripping section in said compartment as stripping vapor for the stripping zone of the other compartment of the fractionation column, instead of using two inlets of two different stripping vapor streams in said column. This makes it possible to limit the loss of yield associated with the dilution of the HPNAs in the purge.

U.S. Pat. No. 9,580,663 describes a hydrocracking process wherein the HPNAs are concentrated in the unconverted fraction (UCO) so that they can be removed, this resulting in conversion and an improved yield. In particular, said U.S. Pat. No. 9,580,663 describes a hydrocracking process wherein a portion of the unconverted fraction (UCO) from the bottom of the fractionation column is stripped in countercurrent mode in a stripping column external to said fractionation column, so as to produce a vapor fraction at the top of the stripping column which is then recycled to the bottom of the fractionation column, and a stripped liquid fraction with a high concentration of HPNAs. This heavy liquid fraction with a high concentration of HPNAs is at least partly purged, it being possible for the other portion of this fraction to be recycled to the stripping column. This process makes it possible to concentrate the HPNAs before they are purged. The high concentration of HPNAs in the heavy liquid fraction allows the removal of HPNAs at a lower purge flow rate, which results in a higher total process conversion with an improved upgradable product yield being obtained.

These processes have brought about improvements in terms of reducing the HPNAs, but often to the detriment of the yields of desired upgradable products and the costs.

The research studies carried out by the applicant have led it to discover that the implementation, in a two-step hydrocracking process, of a distillation step wherein a dividing wall distillation column is used, said dividing wall dividing only the lower part of said column into two compartments and being located in the section of the column below the point at which said column is fed with the liquid hydrocarbon effluent from the first hydrocracking step, makes it possible to concentrate the HPNAs in a specific compartment, delimited by said dividing wall within the column and to purge them so that they are twice as pure as in a process not using said dividing wall.

Indeed, the distillation column is fed on either side of the vertical dividing wall, on the one hand, with the liquid hydrocarbon effluent from the first hydrocracking step and, on the other hand, with the liquid hydrocarbon effluent from the second hydrocracking step, thus allowing the concentration of the HPNAs contained in the effluent from the second hydrocracking step in a specific compartment of the column delimited by said dividing wall and thus avoiding the dilution of said HPNAs by the liquid hydrocarbon effluent from the first hydrocracking step.

Thus, the HPNAs can be purged purer. At the same partial flow rate of HPNAs, the purge stream is smaller. However, the conversion in a two-step hydrocracking process is directly linked to the amount of heavy products purged at the same time as the HPNAs. Increasing the HPNA concentration in the purge decreases the amount of unconverted product extracted from the process, thus maximizing the total process conversion.

Another advantage of the invention is to provide a process which makes it possible to increase the cycle time of the second hydrocracking step at the same total conversion in the process.

### SUBJECT MATTER OF THE INVENTION

In particular, the present invention relates to a two-step process for hydrocracking hydrocarbon feedstocks containing at least 20% by volume and preferably at least 80% by volume of compounds boiling above 340° C., said process comprising at least the following steps:
a) a step of hydrotreating said feedstocks in the presence of hydrogen and at least one hydrotreating catalyst, at a temperature of between 200° C. and 400° C., under a pressure of between 2 and 16 MPa, at a space velocity of between 0.2 and 5 h⁻¹ and with an amount of hydrogen introduced such that the liter of hydrogen/liter of hydrocarbon ratio by volume is between 100 and 2000 l/l,
b) a step of hydrocracking at least one portion of the effluent from step a), the hydrocracking step b) taking place, in the presence of hydrogen and at least one hydrocracking catalyst, at a temperature of between 250° C. and 480° C., under a pressure of between 2 and 25 MPa, at a space velocity of between 0.1 and 6 h⁻¹ and with an amount of hydrogen introduced such that the liter of hydrogen/liter of hydrocarbon ratio by volume is between 80 and 5000 l/l,
c) a step of separating at high pressure the effluent from the hydrocracking step b) to produce at least a gaseous effluent and a liquid hydrocarbon effluent,
d) a step of distilling at least one portion of the liquid hydrocarbon effluent from step c) carried out in at least one distillation column comprising a vertical dividing wall in the bottom of said column, dividing the bottom of said column into two separate compartments, the first compartment and the second compartment, by introducing said effluent into the first compartment, at a level lower than or equal to the upper end of said dividing wall, from which step the following are withdrawn:
   optionally a gaseous fraction,
   optionally a gasoline fraction boiling at a temperature below 150° C.,
   a middle distillates fraction having a boiling point between 150° C. and 370° C., preferably between 150° C. and 350° C. and preferably between 150° C. and 340° C.,
   an unconverted liquid fraction having a boiling point greater than 340° C. and preferably greater than 350° C. and preferably greater than 370° C., withdrawn at the lower end of said first compartment, and
   an unconverted heavy liquid fraction containing HPNAs, having a boiling point greater than 340° C. and preferably greater than 350° C. and preferably greater than 370° C., withdrawn at the lower end of said second compartment delimited by said dividing wall,
e) the purging of at least one portion of said unconverted heavy liquid fraction containing HPNAs, having a boiling point greater than 340° C. and preferably greater than 350° C. and preferably greater than 370° C., withdrawn at the lower end of said second compartment of the distillation column of step d),
f) a second step of hydrocracking at least one portion of the unconverted liquid fraction having a boiling point greater than 340° C. and preferably greater than 350° C. and preferably greater than 370° C. from step d) withdrawn from the lower end of said first compartment of the distillation column, mixed with the unpurged portion of the unconverted heavy liquid fraction containing HPNAs, having a boiling point greater than 340° C. and preferably greater than 350° C. and preferably greater than 370° C. from step d), withdrawn at the lower end of said second compartment, said step f) operating in the presence of hydrogen and of at least a second hydrocracking catalyst, at a temperature of between 250 and 480° C., under a pressure of between 2 and 25 MPa, at a space velocity between 0.1 and 6 h⁻¹ and with an amount of hydrogen introduced such that the liter of hydrogen/liter of hydrocarbon ratio by volume is between 100 and 2000 l/l,
g) a step of separating at high pressure the effluent from the second hydrocracking step f) to produce at least a gaseous effluent and a liquid hydrocarbon effluent,
h) recycling into the second compartment delimited by the dividing wall of said distillation step d), at least one portion of said liquid hydrocarbon effluent from step g), at a level below the upper end of said dividing wall.

### DETAILED DESCRIPTION OF THE INVENTION

### Feedstocks

The present invention relates to a process for hydrocracking hydrocarbon feedstocks referred to as mother feedstock, containing at least 20% by volume, and preferably at least 80% by volume, of compounds boiling above 340° C., preferably above 350° C. and preferably between 340° C. and 580° C. (i.e. corresponding to compounds containing at least 15 to 20 carbon atoms).

Said hydrocarbon feedstocks may advantageously be chosen from VGOs (vacuum gas oils) or vacuum distillates (VDs), for instance gas oils resulting from the direct distillation of crude or from conversion units, such as FCC units (such as LCO or Light Cycle Oil), coker or visbreaking units, and also feedstocks originating from units for the extraction of aromatics from lubricating oil bases or resulting from the solvent dewaxing of lubricating oil bases, or else distillates originating from the desulfurization or hydroconversion of ATRs (atmospheric residues) and/or VRs (vacuum residues), or else the feedstock may advantageously be a deasphalted oil, or feedstocks resulting from biomass or any mixture of the feedstocks mentioned previously, and preferably VGOs.

Paraffins resulting from the Fischer-Tropsch process are excluded.

In general, said feedstocks have a boiling point T5 greater than 340° C., and even better still greater than 370° C., that is to say that 95% of the compounds present in the feedstock have a boiling point greater than 340° C., and even better still above 370° C.

The nitrogen content of the mother feedstocks treated in the process according to the invention is usually greater than 500 ppm by weight, preferably between 500 and 10000 ppm by weight, more preferably between 700 and 4000 ppm by weight and more preferably still between 1000 and 4000 ppm by weight. The sulfur content of the mother feedstocks treated in the process according to the invention is usually between 0.01% and 5% by weight, preferably between 0.2% and 4% by weight and more preferably still between 0.5% and 3% by weight.

The feedstock may optionally contain metals. The cumulative content of nickel and vanadium of the feedstocks treated in the process according to the invention is preferably less than 1 ppm by weight.

The asphaltene content is generally less than 3000 ppm by weight, preferably less than 1000 ppm by weight and even more preferably less than 200 ppm by weight.

The feedstock may optionally contain asphaltenes. The asphaltene content is generally less than 3000 ppm by weight, preferably less than 1000 ppm by weight and even more preferably less than 200 ppm by weight.

In the case where the feedstock contains compounds of resin and/or asphaltene type, it is advantageous to pass the feedstock beforehand over a bed of catalyst or of adsorbent different than the hydrocracking or hydrotreating catalyst.

### Step a)

In accordance with the invention, the process comprises a step a) of hydrotreating said feedstocks in the presence of hydrogen and at least one hydrotreating catalyst, at a temperature of between 200° C. and 450° C., under a pressure of between 2 and 18 MPa, at a space velocity of between 0.1 and 6 h⁻¹ and with an amount of hydrogen introduced such that the liter of hydrogen/liter of hydrocarbon ratio by volume is between 100 and 2000 l/l.

The operating conditions such as temperature, pressure, degree of hydrogen recycling or hourly space velocity, may be highly variable depending on the nature of the feedstock, on the quality of the products desired and on the plants which the refiner has at his disposal.

Preferably, the hydrotreating step a) according to the invention takes place at a temperature of between 250° C. and 450° C., very preferably between 300° C. and 430° C., under a pressure of between 5 and 16 MPa, at a space velocity of between 0.2 and 5 h⁻¹ and with an amount of hydrogen introduced such that the liter of hydrogen/liter of hydrocarbon ratio by volume is between 300 and 1500 l/l.

Conventional hydrotreating catalysts may advantageously be used, preferably which contain at least one amorphous support and at least one hydro-dehydrogenating element chosen from at least one non-noble element from Groups VIB and VIII, and usually at least one element from Group VIB and at least one non-noble element from Group VIII.

Preferably, the amorphous support is alumina or silica/alumina.

Preferred catalysts are chosen from the catalysts NiMo, NiW or CoMo on alumina, and NiMo or NiW on silica-alumina.

The effluent from the hydrotreating step and which enters the hydrocracking step b) generally comprises a nitrogen content preferably of less than 300 ppm by weight and preferably of less than 50 ppm by weight.

### Step b)

In accordance with the invention, the process comprises a step b) of hydrocracking at least one portion of the effluent from step a), and preferably all thereof, said step b) taking place, in the presence of hydrogen and at least one hydrocracking catalyst, at a temperature of between 250° C. and 480° C., under a pressure of between 2 and 25 MPa, at a space velocity of between 0.1 and 6 h⁻¹ and with an amount of hydrogen introduced such that the liter of hydrogen/liter of hydrocarbon ratio by volume is between 100 and 2000 l/l.

Preferably, the hydrocracking step b) according to the invention takes place at a temperature of between 320° C. and 450° C., very preferably between 330° C. and 435° C., under a pressure of between 3 and 20 MPa, at a space velocity of between 0.2 and 4 h⁻¹ and with an amount of hydrogen introduced such that the liter of hydrogen/liter of hydrocarbon ratio by volume is between 200 and 2000 l/l.

In one embodiment that makes it possible to maximize the production of middle distillates, the operating conditions used in the process according to the invention generally make it possible to obtain conversions per pass, into products having boiling points below 340° C., and better still below 370° C., of greater than 15% by weight and more preferably still of between 20% and 95% by weight.

In one embodiment that makes it possible to maximize the production of naphtha, the operating conditions used in the process according to the invention generally make it possible to obtain conversions per pass, into products having boiling points below 190° C., and better still below 175° C., of greater than 15% by weight and more preferably still of between 20% and 95% by weight.

The hydrocracking process according to the invention covers the pressure and conversion ranges extending from mild hydrocracking to high-pressure hydrocracking. The term “mild hydrocracking” refers to hydrocracking which results in moderate conversions, generally of less than 40%, and which is carried out at low pressure, preferably between 2 MPa and 6 MPa. High-pressure hydrocracking is generally carried out at greater pressures, between 5 MPa and 20 MPa, so as to obtain conversions of greater than 50%.

The hydrocracking process according to the invention is carried out in two steps, independently of the pressure at which said process is implemented. It is carried out in the presence of one or more hydrocracking catalyst(s), in one or more reaction unit(s) equipped with one or more fixed bed or ebullated bed reactor(s), possibly separated from one or more high and/or low pressure separation sections.

The hydrotreating step a) and the hydrocracking step b) may advantageously be carried out in the same reactor or in different reactors. When they are carried out in the same reactor, the reactor comprises several catalytic beds, the first catalytic beds comprising the hydrotreating catalyst(s) and the following catalytic beds comprising the hydrocracking catalyst(s).

### Catalyst for the Hydrocracking Step b)

The hydrocracking catalysts used in the hydrocracking step b) are conventional hydrocracking catalysts, of bifunctional type combining an acid function with a hydrogenating function and optionally at least one binder matrix.

Preferably, the hydrocracking catalyst(s) comprise at least one metal from Group VIII chosen from iron, cobalt, nickel, ruthenium, rhodium, palladium and platinum and preferably cobalt and nickel and/or at least one metal from Group VIb chosen from chromium, molybdenum and tungsten, alone or as a mixture, and preferably from molybdenum and tungsten.

Hydrogenating functions of NiMo, NiMoW, NiW type are preferred.

Preferably, the content of metal from Group VIII in the hydrocracking catalyst(s) is advantageously between 0.5% and 15% by weight and preferably between 2% and 10% by weight, the percentages being expressed as percentage by weight of oxides.

Preferably, the content of metal from Group VIb in the hydrocracking catalyst(s) is advantageously between 5% and 25% by weight and preferably between 15% and 22% by weight, the percentages being expressed as percentage by weight of oxides.

The catalyst(s) can also optionally comprise at least one promoter element deposited on the catalyst and chosen from the group formed by phosphorus, boron and silicon, optionally at least one element from Group Vila (chlorine, fluorine are preferred), and optionally at least one element from Group VIIb (manganese preferred), optionally at least one element from Group Vb (niobium preferred).

Preferably, the hydrocracking catalyst(s) comprise a zeolite chosen from USY zeolites, alone or in combination, with other zeolites from among beta, ZSM-12, IZM-2, ZSM-22, ZSM-23, SAPO-11, ZSM-48 and ZBM-30 zeolites, alone or as a mixture. Preferably the zeolite is the USY zeolite alone.

The hydrocracking catalyst(s) may optionally comprise at least one porous or poorly crystallized mineral matrix of oxide type chosen from aluminas, silicas, silica-aluminas, aluminates, alumina-boron oxide, magnesia, silica-magnesia, zirconia, titanium oxide, clay, alone or as a mixture, and preferably alumina.

A preferred catalyst comprises and preferably consists of at least one metal from Group VI and/or at least one non-noble metal from Group VIII, a zeolite Y and an alumina binder.

An even more preferred catalyst comprises and preferably consists of nickel, molybdenum, phosphorus, a Y zeolite and alumina.

Another preferred catalyst comprises, and preferably consists of nickel, tungsten, a Y zeolite and alumina or silica-alumina.

In general, the catalyst(s) used in hydrocracking step b) advantageously contain:
0.1 to 60% by weight of zeolite,
0.1 to 40% by weight of at least one element of groups VIB and VIII (% oxide)
0.1 to 99.8% by weight of matrix (% oxide)
0 to 20% by weight of at least one element chosen from the group formed by P, B, Si (% oxide), preferably 0.1-20%
0 to 20% by weight of at least one element of group VIIA, preferably 0.1 to 20%
0 to 20% by weight of at least one element of group VIIB, preferably 0.1 to 20%
0 to 60% by weight of at least one element of group VB, preferably 0.1 to 60%;

the percentages being expressed as percentage by weight relative to the total weight of catalyst, the sum of the percentages of the constituent elements of said catalyst being equal to 100%.

### Step c)

In accordance with the invention, the process comprises a high-pressure separation step c) comprising a separation means, for instance a series of disengagers at high pressure operating between 2 and 25 MPa, the purpose of which is to produce a stream of hydrogen which is recycled by means of a compressor to at least one of steps a), b) and/or e), and a hydrocarbon effluent produced in the hydrocracking step b) which is preferentially sent to a steam stripping step preferably operating at a pressure of between 0.5 and 2 MPa, the purpose of which is to perform separation of the dissolved hydrogen sulfide (H₂S) from at least said hydrocarbon effluent produced in step b).

Step c) allows the production of a liquid hydrocarbon effluent which is then sent to the distillation step d).

### Step d)

In accordance with the invention, the process comprises a step d) of distillation of the liquid hydrocarbon effluent from step c).

According to the invention, said distillation step d) is carried out in at least one distillation column comprising a vertical dividing wall in the bottom of said column, dividing the bottom of said column into two separate compartments, a first compartment and a second compartment, and preferably at least the lower two thirds of said column and preferably at least one third of said column.

The distillation column operates at a pressure of between 0.1 and 0.4 MPa absolute.

Said dividing wall delimiting two separate compartments is therefore located at the lower end of said column.

The upper part of the column without a dividing wall is called the top compartment.

According to the invention, the liquid hydrocarbon effluent separated in step c) and resulting from the first hydrocracking step b) is introduced into the first compartment, at a level lower than or equal to the upper end of said dividing wall.

The first compartment can advantageously comprise between 8 and 25 theoretical plates, advantageously between 12 and 20. The second compartment can advantageously comprise between 8 and 25 theoretical plates, advantageously between 12 and 20.

The liquid hydrocarbon effluent separated in step c) and resulting from the first hydrocracking step b) is fed at a plate located in the upper half of said first compartment. Thus, if for example the first compartment comprises 14 theoretical stages, said effluent is fed between the plates 1 and 7, the plates being numbered in the direction of flow of the liquid.

In accordance with the invention, the distillation column is fed on either side of the vertical dividing wall, on the one hand, with the liquid hydrocarbon effluent from the first hydrocracking step b) via the separation step c) and, on the other hand, with the liquid hydrocarbon effluent from the second hydrocracking step f) via the separation step g), thus allowing the concentration of the HPNAs contained in the effluent from the second hydrocracking step f) in a specific compartment of the column delimited by said dividing wall (the second compartment) and thus avoiding the dilution of said HPNAs by the liquid hydrocarbon effluent from the first hydrocracking step b) and separated in step c).

Said distillation step d) makes it possible to withdraw:
optionally a gaseous fraction, and optionally at least one gasoline fraction boiling at a temperature below 150° C.,
a middle distillates fraction and preferably a single middle distillate fraction having a boiling point between 150° C. and 370° C., preferably between 150° C. and 350° C. and preferably between 150° C. and 340° C.,
a liquid fraction not converted in steps a) and b), having a boiling point greater than 340° C. and preferably greater than 350° C. and preferably greater than 370° C., withdrawn at the lower end of said first compartment, and
a heavy liquid fraction not converted in the second hydrocracking step e), containing HPNAs and having a boiling point greater than 340° C. and preferably greater than 350° C. and preferably greater than 370° C., said fraction being withdrawn at the lower end of said second compartment.

The two separate compartments integrated into a single atmospheric distillation column and located at the lower end of said column make it possible to separate, on the one hand, the unconverted liquid fraction from steps a) and b) and, on the other hand, the unconverted liquid fraction from step f). The presence of said wall makes it possible to avoid the mixing of these two unconverted fractions and therefore the dilution of the HPNAs contained in said heavy liquid fraction not converted in the second hydrocracking step f) by the liquid hydrocarbon effluent from step c) corresponding to the liquid hydrocarbon effluent from the first hydrocracking step b).

### Step e)

In accordance with the invention, the process comprises a step e) of purging at least one portion of said heavy liquid fraction not converted in the second hydrocracking step f), containing HPNAs, and withdrawn at the level of the lower end of said second compartment of the distillation column of step d).

The purge stream is predominantly composed of products from the second hydrocracking step f) via the separation step g) and is not diluted by the molecules from the first hydrocracking step b). The objective of the purge is to extract as much HPNA as those formed in the process (especially in step f). The invention makes it possible not to dilute the HPNAs and therefore to purge from the process a smaller amount of products of interest at the same partial flow rate of HPNAs purged (and therefore the same partial flow rate of HPNAs formed).

The implementation of the process also makes it possible to increase the cycle time of the second hydrocracking step at the same total conversion of the process.

### Step f)

In accordance with the invention, the process comprises a second step f) of hydrocracking at least one portion and preferably all of the liquid fraction not converted in steps a) and b) and having a boiling point greater than 340° C. and preferably greater than 350° C. and preferably greater than 370° C., withdrawn at the lower end of said first compartment of the distillation column of step d), mixed with the unpurged portion of the heavy liquid fraction not converted in step e), said fraction containing HPNAs, having a boiling point greater than 340° C. and preferably greater than 350° C. and preferably greater than 370° C., and withdrawn at the lower end of said second compartment of the distillation column of step d).

Preferably, the feedstock from step f) consists solely of a portion and preferably all of the liquid fraction not converted in steps a) and b) and having a boiling point greater than 340° C. and of the unpurged portion of the heavy liquid fraction not converted in step e), said fraction containing HPNAs, having a boiling point greater than 340° C.

Preferably, the middle distillate fraction withdrawn in the distillation step d) is not recycled to the hydrocracking step f).

According to the invention, said step f) operates in the presence of hydrogen and of at least a second hydrocracking catalyst, at a temperature of between 250 and 480° C., under a pressure of between 2 and 25 MPa, at a space velocity of between 0.1 and 6 h⁻¹ and with an amount of hydrogen introduced such that the liter of hydrogen/liter of hydrocarbon ratio by volume is between 100 and 2000 l/l.

The recycle ratio is defined as being the weight ratio between the feedstock stream entering step f) and the hydrocarbon feedstock entering said process (in step a) and is between 0.2 and 4, preferably between 0.5 and 2.

Preferably, the hydrocracking step f) according to the invention takes place at a temperature of between 320° C. and 450° C., very preferably between 330° C. and 435° C., under a pressure of between 3 and 20 MPa, and very preferably between 9 and 20 MPa, at a space velocity of between 0.2 and 3 h⁻¹ and with an amount of hydrogen introduced such that the liter of hydrogen/liter of hydrocarbon ratio by volume is between 100 and 2000 l/l.

In the embodiment that makes it possible to maximize the production of middle distillates, these operating conditions used in step f) of the process according to the invention generally make it possible to obtain conversions per pass, into products having boiling points below 380° C., preferably below 370° C., and preferably below 340° C., of greater than 15% by weight and more preferably still of between 20% and 80% by weight. Nevertheless, the conversion per pass in step f) is generally between 10 and 80% by weight, preferably between 20 and 70% by weight and preferably between 30 and 60% by weight in order to maximize the selectivity of the process for product having boiling points of between 150 and 370° C. (middle distillates). The conversion per pass is limited by the use of a high recycle ratio over the loop of the second hydrocracking step f). This ratio is defined as the ratio of the feed flow rate of step f) to the flow rate of the feedstock of step a); preferentially, this ratio is between 0.2 and 4, preferably between 0.5 and 2.

In the embodiment that makes it possible to maximize the production of naphtha, these operating conditions used in step f) of the process according to the invention generally make it possible to obtain conversions per pass, into products having boiling points below 190° C., preferably below 175° C., and preferably below 150° C., of greater than 15% by weight and more preferably still of between 20% and 80% by weight. Nevertheless, the conversion per pass in step f) is kept low in order to maximize the selectivity of the process to give products having boiling points of between 80° C. and 190° C. (naphtha). The conversion per pass is limited by the use of a high recycle ratio over the loop of the second hydrocracking step f). This ratio is defined as the ratio of the feed flow rate of step f) to the flow rate of the feedstock of step a); preferentially, this ratio is between 0.2 and 4, preferably between 0.5 and 2.

In accordance with the invention, the hydrocracking step f) is carried out in the presence of at least one hydrocracking catalyst. Preferably, the second-step hydrocracking catalyst is chosen from conventional hydrocracking catalysts known to those skilled in the art. The hydrocracking catalyst used in said step f) may be identical to or different than the one used in step b) and is preferably different.

The hydrocracking catalysts used in the hydrocracking processes are all of the bifunctional type combining an acid function with a hydrogenating function. The acid function is provided by supports having large surface areas (generally 150 to 800 m²·g-1) having surface acidity, such as halogenated (in particular chlorinated or fluorinated) aluminas, combinations of boron and aluminum oxides, amorphous silica/aluminas and zeolites. The hydrogenating function is contributed either by one or more metals from Group VIII of the Periodic Table of the Elements or by a combination of at least one metal from Group VIb of the Periodic Table and at least one metal from Group VIII.

Preferably, the hydrocracking catalyst(s) used in step f) comprise a hydrogenating function comprising at least one metal from Group VIII chosen from iron, cobalt, nickel, ruthenium, rhodium, palladium and platinum and preferably cobalt and nickel and/or at least one metal from Group VIb chosen from chromium, molybdenum and tungsten, alone or as a mixture, and preferably from molybdenum and tungsten.

Preferably, the content of metal from Group VIII in the hydrocracking catalyst(s) is advantageously between 0.5% and 15% by weight and preferably between 2% and 10% by weight, the percentages being expressed as percentage by weight of oxides.

Preferably, the content of metal from Group VIb in the hydrocracking catalyst(s) is advantageously between 5% and 25% by weight and preferably between 15% and 22% by weight, the percentages being expressed as percentage by weight of oxides.

The catalyst(s) used in step e) can also optionally comprise at least one promoter element deposited on the catalyst and chosen from the group formed by phosphorus, boron and silicon, optionally at least one element from Group Vila (chlorine, fluorine are preferred), and optionally at least one element from Group VIIb (manganese preferred), optionally at least one element from Group Vb (niobium preferred).

Preferably, the hydrocracking catalyst(s) used in step e) comprise an acid function chosen from alumina, silica/alumina and zeolites, preferably chosen from zeolites Y, and preferably chosen from silica/alumina and zeolites.

A preferred catalyst used in step e) comprises and preferably consists of at least one metal from Group VI and/or at least one non-noble metal from Group VIII, a Y zeolite and alumina.

An even more preferred catalyst comprises and preferably consists of nickel, molybdenum, a zeolite Y and alumina.

Another preferred catalyst comprises, and preferably consists of, nickel, tungsten and alumina or silica/alumina.

### Step g)

In accordance with the invention, the process comprises a step g) of high-pressure separation of the effluent from the second hydrocracking step f), said step comprising a separation means, for instance a series of disengagers at high pressure operating between 2 and 25 MPa, the purpose of which is to produce a stream of hydrogen which is recycled by means of a compressor to at least one of steps a), b) and/or f), and a hydrocarbon effluent produced in the hydrocracking step f) which can optionally be sent to a steam stripping step preferably operating at a pressure of between 0.5 and 2 MPa, the purpose of which is to perform separation of the dissolved hydrogen sulfide (H₂S) from at least said hydrocarbon effluent produced in step f).

Step g) also allows the production of a liquid hydrocarbon effluent which is then sent in total or in part to the distillation column of step d) and in particular to the second compartment of step d).

### Step h)

In accordance with the invention, said process comprises the recycling of at least one portion and preferably all of said liquid hydrocarbon effluent from step g) to the second compartment delimited by the dividing wall of said distillation step d), at a level lower than the upper end of said dividing wall.

### DESCRIPTION OF THE FIGURE

The VD feedstock is introduced into the hydrotreatment step a) via the line 1. The effluent from step a) via the line 2 is sent to the first hydrocracking step b). The effluent from step b) via the line 3 is sent to a step c) of high-pressure separation of the effluent from the hydrocracking step b) to produce at least one gaseous effluent (not shown in the FIGURE) and a liquid hydrocarbon effluent 4 which is sent to a distillation step d) carried out in at least one distillation column comprising a vertical dividing wall (d1) in the bottom of said column, said dividing wall dividing the lower part of said column into two separate compartments (d′) and (d″), by introducing said effluent into a first compartment (d′), at a level equal to the upper end of said dividing wall.

Said distillation step makes it possible to withdraw:
a gaseous fraction 5,
a gasoline fraction boiling at a temperature below 150° C., preferably below 175° C. in the case of a draining process in order to maximize the production of naphtha via the line 6,
a middle distillates fraction having a boiling point between 150° C. and 370° C., preferably between 150° C. and 350° C. and preferably between 150° C. and 340° C., via the line 7,
an unconverted liquid fraction having a boiling point greater than 340° C., withdrawn at the level of the lower end of a first compartment (d′) via the line 8, and
an unconverted heavy liquid fraction containing HPNAs, having a boiling point greater than 340° C. withdrawn at the level of the lower end of a second compartment (d″) delimited by said dividing wall, via the line 12.

A purge of a portion of said unconverted heavy liquid fraction containing HPNAs, having a boiling point greater than 340° C., is withdrawn via the line 13 at the lower end of said second compartment (d″) of the distillation column of step d).

All of the unconverted liquid fraction having a boiling point greater than 340° C. from step d) withdrawn at the level of the lower end of said first compartment (d′) of the distillation column is sent to the second hydrocracking step f) mixed with the unpurged portion of the unconverted heavy liquid fraction containing HPNAs, having a boiling point greater than 340° C. from step d), withdrawn at the level of the lower end of said second compartment (d″), via the line 9.

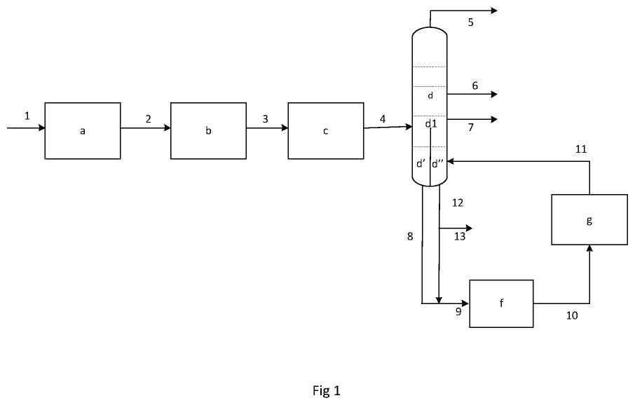

The effluent from the second hydrocracking step f) is sent to a high-pressure separation step g) via the line 10 to produce at least one gaseous effluent not shown in FIG. 1 and a liquid hydrocarbon effluent via the line 11.

Said liquid hydrocarbon effluent is then recycled, via the line 11, to the second compartment (d″) delimited by the dividing wall of said distillation step d), at a level below the upper end of said dividing wall.

### EXAMPLES—GAS OIL MAXIMIZATION MODE

### Example 1: Not in Accordance with the Invention

The hydrocracking unit treats a vacuum gas oil (VGO) feedstock described in table 1:

TABLE 1

| Type | | VGO |
|---|---|---|
| Flow rate | t/h | 49 |
| Density | t/m³ | 0.92 |
| SP TBP | ° C. | 300 |
| FP TBP | ° C. | 552 |
| S | wt % | 2.18 |
| N | ppm by | 1800 |
| | weight | |

The VGO feedstock is injected into a preheating step and then into a hydrotreating reactor under the following conditions set out in table 2:

TABLE 2

| Reactor | R1 |
|---|---|
| Temperature ° C. | 385 |
| H₂ partial pressure MPa | 14 |
| Catalyst | NiMo on alumina |
| HSV h⁻¹ | 1.67 |

The catalyst used is a CoMo-on-alumina catalyst.

The effluent from this reactor is subsequently mixed with a hydrogen stream in order to be cooled and is then injected into a second “hydrocracking” reactor R2 operating under the conditions of table 3:

TABLE 3

| Reactor | R2 |
|---|---|
| Temperature ° C. | 390 |
| H₂ partial pressure MPa | 12.5 |
| Catalyst | Metal on zeolite |
| HSV h⁻¹ | 3 |

The catalyst used is a metal-on-zeolite catalyst.

R1 and R2 constitute the first hydrocracker step, the effluent from R2 is then sent to a separation step composed of a train for recovery of heat and then for high-pressure separation including a recycle compressor and making it possible to separate, on the one hand, hydrogen, hydrogen sulfide and ammonia and, on the other hand, the liquid hydrocarbon effluent feeding a stripper then an atmospheric distillation column in order to separate streams concentrated with respect to H₂S, naphtha, kerosene, gas oil to the desired specification, and an unconverted heavy liquid effluent. The atmospheric distillation column is not provided with a vertical dividing wall in its lower section. Said unconverted heavy liquid effluent is injected into a hydrocracking reactor R3 constituting the second hydrocracking step. This reactor R3 is used under the following conditions set out in table 4:

TABLE 4

| Reactor | R3 |
|---|---|
| Temperature ° C. | 345 |
| H₂ partial pressure MPa | 12.5 |
| Catalyst | Metal on amorphous silica/alumina |
| HSV h⁻¹ | 3 |

The catalyst used is a metal-on-amorphous silica/alumina catalyst.

The effluent from R3 is subsequently injected into the high-pressure separation step downstream of the first hydrocracking step. The flow rate by weight at the inlet of the reactor R3 is equal to the flow rate by weight of the VGO feedstock; a purge corresponding to 2% by weight of the flow rate of the VGO feedstock is taken at the distillation bottom on the unconverted oil stream.

The distillate cut produced in the hydrocracker and recovered from the distillation column is in accordance with the Euro V specifications; in particular, it has less than 10 ppm by weight of sulfur.

The HPNA concentration in the recycle loop is 1000 ppm by weight.

The yield of middle distillates of this process is 85% by weight, for an overall conversion of 98% by weight of the hydrocarbons having a boiling point of greater than 380° C.

### Example 2: In Accordance with the Invention

Example 2 relates to a two-step hydrocracking process carried out under the same conditions and operating the same feedstock as in example 1 with the difference that the disitillation column comprises a vertical dividing wall in the bottom of said column, and 2 actual trays above the injection of the feed of said column and down as far as the bottom of the column, said dividing wall dividing said column into two separate compartments. In example 2, the bottom of the atmospheric distillation column is divided into two compartments treating, on one side the liquid hydrocarbon effluent coming from R2 and on the other side the liquid hydrocarbon effluent coming from R3.

In example 2, the stripped liquid hydrocarbon effluent feeds a first compartment of said atmospheric distillation column. Said compartment allows the separation of a liquid fraction not converted in the hydrotreatment and hydrocracking steps carried out in R1 and R2, having a boiling point of 340° C.

This fraction is withdrawn at the level of the lower end of said first compartment and sent to the hydrocracking reactor R3 constituting the second hydrocracking step, mixed with the unpurged portion of the liquid fraction not converted in R3 and having a boiling point of 340° C.

The liquid hydrocarbon effluent from R3 and after high-pressure separation is recycled into the second compartment of the atmospheric distillation column.

Said second compartment allows the separation of a liquid fraction not converted in the hydrocracking step carried out in R3, having a boiling point of 340° C.

Said unconverted liquid fraction comprises H PNAs.

In example 2, the purge corresponds to 1% by weight of the flow rate of the VGO feedstock. Since the purge flow rate is reduced by half, the HPNA concentration in the recycle loop is kept equal to that of example 1. The HPNA concentration in the recycle loop is therefore 1000 ppm by weight.

Thus, the catalytic cycle time is identical in the two examples. The yield of middle distillates of this process is 86% by weight, for an overall conversion of 99% by weight of the hydrocarbons having a boiling point of greater than 380° C.

1. A two-step process for the hydrocracking of hydrocarbon feedstocks containing at least 20% by volume and preferably at least 80% by volume of compounds boiling above 340° C., said process comprising at least the following steps:
a) a step of hydrotreating said feedstocks in the presence of hydrogen and at least one hydrotreating catalyst, at a temperature of between 200° C. and 400° C., under a pressure of between 2 and 16 MPa, at a space velocity of between 0.2 and 5 h⁻¹ and with an amount of hydrogen introduced such that the liter of hydrogen/liter of hydrocarbon ratio by volume is between 100 and 2000 l/l,
b) a step of hydrocracking at least one portion of the effluent from step a), the hydrocracking step b) taking place, in the presence of hydrogen and at least one hydrocracking catalyst, at a temperature of between 250° C. and 480° C., under a pressure of between 2 and 25 MPa, at a space velocity of between 0.1 and 6 h⁻¹ and with an amount of hydrogen introduced such that the liter of hydrogen/liter of hydrocarbon ratio by volume is between 80 and 5000 l/l,
c) a step of separating at high pressure the effluent from the hydrocracking step b) to produce at least a gaseous effluent and a liquid hydrocarbon effluent,
d) a step of distilling at least one portion of the liquid hydrocarbon effluent from step c) carried out in at least one distillation column comprising a vertical dividing wall in the bottom of said column, dividing the bottom of said column into two separate compartments, the first compartment and the second compartment, by introducing said effluent into the first compartment, at a level lower than or equal to the upper end of said dividing wall, from which step the following are withdrawn:
optionally a gaseous fraction,
optionally at least one gasoline fraction boiling at a temperature below 150° C.,
a middle distillates fraction having a boiling point between 150° C. and 370° C., preferably between 150° C. and 350° C. and preferably between 150° C. and 340° C.,
an unconverted liquid fraction having a boiling point greater than 340° C., withdrawn at the level of the lower end of said first compartment, and
an unconverted heavy liquid fraction containing HPNAs, having a boiling point greater than 340° C., withdrawn at the level of the lower end of said second compartment delimited by said dividing wall,
e) the purge of at least one portion of said unconverted heavy liquid fraction containing HPNAs, having a boiling point greater than 340° C., is withdrawn via the line 13 at the lower end of said second compartment of the distillation column of step d),
f) a second step of hydrocracking at least one portion of the unconverted liquid fraction having a boiling point greater than 340° C. from step d) withdrawn from the lower end of said first compartment of the distillation column, mixed with the unpurged portion of the unconverted heavy liquid fraction containing HPNAs, having a boiling point greater than 340° C. from step d), withdrawn at the lower end of said second compartment, said step f) operating in the presence of hydrogen and of at least a second hydrocracking catalyst, at a temperature of between 250 and 480° C., under a pressure of between 2 and 25 MPa, at a space velocity between 0.1 and 6 h⁻¹ and with an amount of hydrogen introduced such that the liter of hydrogen/liter of hydrocarbon ratio by volume is between 100 and 2000 l/l,
g) a step of separating at high pressure the effluent from the second hydrocracking step f) to produce at least a gaseous effluent and a liquid hydrocarbon effluent,
h) recycling into the second compartment delimited by the dividing wall of said distillation step d), at least one portion of said liquid hydrocarbon effluent from step g), at a level below the upper end of said dividing wall.

2. The process as claimed in claim 1, wherein said hydrocarbon feedstocks are chosen from VGOs or vacuum distillates (VDs), such as the gas oils resulting from the direct distillation of crude or from conversion units, such as FCC, coker or visbreaking units, and also feedstocks originating from units for the extraction of aromatics from lubricating oil bases or resulting from the solvent dewaxing of lubricating oil bases, or else distillates originating from the desulfurization or hydroconversion of ATRs (atmospheric residues) and/or VRs (vacuum residues), or else from deasphalted oils, or feedstocks resulting from biomass or else any mixture of the abovementioned feedstocks.

3. The process as claimed in claim 1, wherein the hydrotreating step a) is carried out at a temperature of between 300° C. and 430° C., under a pressure of between 5 and 16 MPa, at a space velocity of between 0.2 and 5 h⁻¹ and with an amount of hydrogen introduced such that the liter of hydrogen/liter of hydrocarbon ratio by volume is between 300 and 1500 l/l.

4. The process as claimed in claim 1, wherein the hydrocracking step b) is carried out at a temperature of between 330° C. and 435° C., under a pressure of between 3 and 20 MPa, at a space velocity of between 0.2 and 4 h⁻¹ and with an amount of hydrogen introduced such that the liter of hydrogen/liter of hydrocarbon ratio by volume is between 200 and 2000 l/l.

5. The process as claimed in claim 1, wherein the distillation column of step d) operates at a pressure of between 0.1 and 0.4 MPa absolute.

6. The process as claimed in wherein the hydrocracking step f) is carried out at a temperature of between 330° C. and 435° C., under a pressure of between 9 and 20 MPa, at a space velocity of between 0.2 and 3 h⁻¹ and with an amount of hydrogen introduced such that the liter of hydrogen/liter of hydrocarbon ratio by volume is between 100 and 2000 l/l.

7. The process as claimed in claim 1, wherein the hydrocracking catalyst used in said step f) is identical to or different than that used in step b).
